(19) United States
(12) Patent Application Publication
(10) Pub. No.: US 2022/0027916 A1
(43) Pub. Date: Jan. 27, 2022

(54) Self Learning Machine Learning Pipeline for Enabling Binary Decision Making

(71) Applicant: Socure, Inc., New York, NY (US)

(72) Inventors: Pablo Ysrrael ABREU, New York, NY (US); Omar GUTIERREZ, New York, NY (US); Lukas Dylan OSBORNE, New York, NY (US)

(73) Assignee: Socure, Inc., New York, NY (US)

(21) Appl. No.: 16/936,475

(22) Filed: Jul. 23, 2020

(51) Int. Cl. G06Q 20/40; G06N 5/02

(52) U.S. Cl. CPC G06Q 20/4016; G06N 20/00; G06N 5/025; G06Q 20/405

(57) ABSTRACT

The system and methodology of the present invention uses feedback data received as a result of previous binary decisions made and uses an applicable score as well as other data, in some cases, to update and optimize a rules base such that scoring is incrementally improved over time as more and more feedback data is provided to the system.

### FIELD OF THE INVENTION

The present invention is directed generally to systems and methodologies associated with enabling binary decision making including when detecting and reporting identity fraud, and, more particularly to systems and methodologies which employ machine learning to enhance the systems and models for assessing the risk of fraud associated with various potential transactions.

### BACKGROUND OF THE INVENTION

In today's business environment, almost all businesses have an online presence, Its also very likely that these businesses permit their customers to conduct transactions online. These transactions almost always involve either a financial component or otherwise require a trust based element. For example, when some form of currency is being used by a customer to purchase a good or a service, it is critical to ensure that the person (or machine) initiating and conducting the transaction is who they say they are. This is important to ensure that the form of payment (e.g. credit card) is authorized for use by the purported purchaser.

If it turns out that this is not the case, then a variety of undesirable results can occur. This can include, but is not limited to, chargebacks and other revenue losses. Even when there is no financial component to a transaction, negative consequences can still result if the user on the other end of the transaction is not who they say they are. For example, businesses may offer other types of online services which provide access to data/content/information, access to sensitive systems or resources, the ability to conduct non-financial transactions impacting the operation of the business as well as other rights and abilities which are intended to be limited only to authorized persons or entities. For obvious reasons, it is very important to do whatever is possible to ensure that the person, entity or machine seeking to conduct these types of interactions are who they say they are and that the purported activity is not fraudulent.

Various fraud detection and identity verification methodologies and related systems for implementing the same exist. While these offerings are generally helpful and effective, they tend to become less so over time and there exists a need for novel approaches to the problem of verifying identities and preventing fraud in connection with online activities. This need exists as online fraud becomes more prevalent and more sophisticated due to the rapid advances in technology which are usually available to fraudsters.

In traditional approaches to fraud detection, static rules-based systems are employed and implemented in real time in connection with decision making associated with online transactions. However, these approaches suffer from a number of drawbacks. For one, the set of rules that make up the model require frequent updates to remain functional and effective. In a static rules-based system, these updates are generally made manually and there is often a lag between the time that a need for a new or changed rule is identified and the time that it is implemented. This often refers in less than ideal results including inaccurate and error prone fraud scoring which drives bad decision making in terms of which transactions are permitted and which are not. These conventional systems are also very dependent on relatively expensive human effort. Risk analysts must be hired and deployed to identify fraud patterns and implement rules designed to protect against them. Similarly, when these large rule sets are created and managed by humans, they are subject to error and omissions due to their complexity as fraud patterns increase and number and complexity.

Other problems also arise with respect to existing fraud detection solutions. One such problem results from changing demographics due to societal trends. Many millennia's as well as individuals falling into other age categories have limited data available which can be used in decision support regarding transactions that these individuals purport to make. This may be due to different attitudes with respect to banking relationships, the use of credit and other financial matters. With limited data available, it is much more difficult for existing models to generate high confidence fraud scores and, again, bad decision making can result.

Yet another concern associated with current fraud identification systems is the impact that they can have on the user experience. In some cases, the process can slow down the transaction and/or add additional confusion. This can result in abandonment of the transaction by the user and possibly loss of revenue and/or other negative impacts to the customer relationship specifically and/or the business in general. Online merchants and other businesses which conduct and offer online transactions are seeking a seamless experience where fraud identification activities occur in the background and are essentially invisible to the user.

Due to the inherent operational characteristics of existing systems, both false positives and false negatives which result from existing models can occur. This can result in preventing a transaction that should be permitted to occur or permitting a transaction to occur when it should not be permitted, respectively. Both situations are undesirable from a business perspective as well as from a customer relations standpoint.

### SUMMARY OF THE INVENTION

Thus, a primary objective of the invention disclosed herein is a system and methodology which addresses the drawbacks of the prior art by employing novel machine learning techniques in order to periodically update and supplement a rules base used in connection with the determination of fraud scores which are typically used to enable binary decisions to be made. The system and methodology of the present invention uses feedback data received as a result of previous binary decisions made and uses the applicable fraud score as well as other data, in some cases, to update and optimize the rules base without the requirement for any human intervention such that fraud scoring is incrementally improved over time as more and more feedback data is provided to the system.

While the present invention is described in the context of generating fraud scores which are used to make binary decisions based on the likelihood of a proposed transaction being fraudulent, the invention is not necessarily limited thereto. Rather, the teachings of the present invention can be applied in any cases where a score which provides guidance in rendering a binary decision is applicable.

Another object of the present invention is to provide a system which allows binary decision making to be made based on fraud scores which reflect the most recent indicators of fraudulent activity as well as the newest techniques and technologies employed by fraudsters in their attempt to implement fraudulent activities. Through the use of feedback sourced from previously made binary decisions as well as the known results, the models can be effectively optimized to more accurately predict the propensity for fraud associated with potential transactions and/or other trust based activities. Because machine learning is employed, much of the human involvement which was required in prior art systems can be eliminated or reduced.

The system and methodology of the present invention operate, in one embodiment, to provide a cloud based application through which an external system can make calls/requests, such as through APIs or other machine to machine protocols, requesting an evaluation of the potential for fraud based on information provided in connection with the call. In preferred embodiments, the information provided to the system of the present invention when calls are made may include personal information which may comprise financial/credit information relating to an individual or entity as well as other personal data associated with that individual or entity. Also, in preferred embodiments, the system of the present invention returns a “fraud score” which is used by the calling system to make a binary decision, which may be, for example, whether or not to permit a transaction, such as opening of a new credit card account, to proceed.

In preferred embodiments of the present invention, the fraud scores are derived from the application of a rules based methodology upon the data received from the calling system in connection with the request. The calling system can then use the fraud scores to make binary decisions based upon criteria that have been predetermined through the configuration of the calling system. In some cases, manual human intervention may be used to make or assist in making the binary decision. The determination as to whether human intervention is needed can be based on a number of factors including the fraud score, the type of transaction being attempted and/or various aspects of the data associated with the individual or entity attempting the transaction as such data is known to either or both of the system of the present invention and/or the calling system.

The system and methodologies of the present invention also periodically receive feedback data from some or all of the calling systems with respect to each of the attempted transactions. In preferred embodiments, this includes whether or not the transaction was authorized and whether or not the transaction turned out to be fraudulent. Other feedback data may also be provided to assist in the optimization process. This data may include, for example, details about the type of transaction, transaction reference numbers, the date that the transaction was recorded as fraudulent or determined to be fraudulent as well as other classes of information.

In preferred embodiments, this feedback data is processed and used by the system of the present invention to optimize existing rules in the rules base so that they operate to generate, in concert with other rules in the rules base, more accurate fraud scores to enable improved binary decision making. In addition to optimizing existing rules, the feedback data may also be used to seed and implement new rules to be employed in the generation of fraud scores. The system of the present invention further employs various steps and processes for assessing new models reflecting updated and new rules and whether or not these new models should be substituted for existing in-use models. This determination can be made based on various factors such as the entity or entities using the models and their specific requirements, anti-bias factors as may be dictated by users and/or regulations and/or the expected accuracy of the new model relative to the in-use model as determined by assessment techniques employed by the system of the present invention.

### BRIEF DESCRIPTION OF THE DRAWINGS

FIG. 1 is a diagram depicting the major components of the system of the present invention including various elements with which the system of the present invention may interact in preferred embodiments thereof;

FIG. 2 is a view of an exemplary data set associated with an fraud score request call received from a client in one embodiment of the present invention;

FIG. 3 is a view of an exemplary data set associate with a fraud score response provided to a client in one embodiment of the present invention;

FIG. 4 is a flow chart describing the key steps involved in the process of generating fraud scores using machine learning based rules optimization according to the teachings of the present invention in preferred embodiments thereof; and

FIG. 5 is an exemplary feedback data set as may be received by the system of the present invention from a client according to a preferred embodiment thereof.

### DETAILED DESCRIPTION OF THE INVENTION

The present disclosure will now be described in terms of various exemplary embodiments. This specification discloses one or more embodiments that incorporate features of the present embodiments. The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. The skilled artisan will appreciate that a particular feature, structure, or characteristic described in connection with one embodiment is not necessarily limited to that embodiment but typically has relevance and applicability to one or more other embodiments.

In the several figures, like reference numerals may be used for like elements having like functions even in different drawings. The embodiments described, and their detailed construction and elements, are merely provided to assist in a comprehensive understanding of the present embodiments. Thus, it is apparent that the present embodiments can be carried out in a variety of ways, and does not require any of the specific features described herein. Also, well-known functions or constructions are not described in detail since they would obscure the present embodiments with unnecessary detail.

The description is not to be taken in a limiting sense, but is made merely for the purpose of illustrating the general principles of the present embodiments, since the scope of the present embodiments are best defined by the appended claims.

It should also be noted that in some alternative implementations, the blocks in a flowchart, the communications in a sequence-diagram, the states in a state-diagram, etc., may occur out of the orders illustrated in the figures. That is, the illustrated orders of the blocks/communications/states are not intended to be limiting. Rather, the illustrated blocks/communications/states may be reordered into any suitable order, and some of the blocks/communications/states could occur simultaneously.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “none of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items. As used herein, the singular forms “a”, “an” and “the” are intended to include the plural forms as well, unless the context clearly indicates otherwise.

The word “exemplary” is used herein to mean “serving as an example, instance, or illustration.” Any embodiment described herein as “exemplary” is not necessarily to be construed as preferred or advantageous over other embodiments. Additionally, all embodiments described herein should be considered exemplary unless otherwise stated.

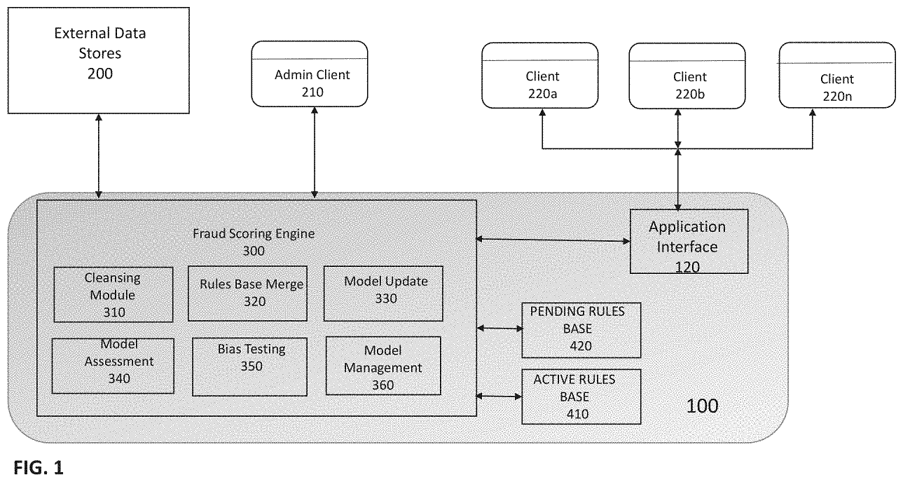

With reference now to FIG. 1, the system of the present invention, in one preferred embodiment thereof, is now described. According to this preferred embodiment, fraud scoring system (FSS) 100 resides on a single cloud based server although it is also possible for various components of FSS 100 (as described herein) to reside on separate servers. By way of example, FSS 100 may be a computer implemented application which resides on a computing server.

FSS 100 preferably includes fraud scoring engine (FSE) 300, which itself is comprised of a number of modules as discussed further herein. FSE 300 operates to generated fraud scores based on received input. These fraud scores are generated in response to requests originating from clients 220a, 220b . . . 220n. FSS 100 may be accessed through the internet or any other private or public network by one or more clients 220.

Each of clients 220 may be personal computers, laptops, handheld computing devices such as smartphones or tablets or any other device capable of providing the required connectivity and display. In some embodiments, client 220 may be a computing application operated by a customer which requires fraud scoring data to process transaction requests. For example, client 220 may be an application or set of applications operated by a financial institution which processes requests for new credit cards made by customers of that financial institution.

Clients 220 interact with FSS 100 such that data may be communicated between them via application interface 120 and such that FSS 100 may process fraud score requests made by clients 220. Application interface 120 may comprise one or more application programming interfaces (APIs) that permit applications associated with client 220 to communicate with FSS 100.

Also shown in FIG. 1 is admin client 210, Admin client 210 may comprise a personal computers, laptops, handheld computing devices such as smartphones or tablets or any other similar device. Adm in client 210 is operative to allow users to configure, maintain and support the operation of FSS 100. For example, a user may use admin client 210 to interact with FSS 100 to set parameters regarding what is required to invoke the transition from an active rules base to a pending rules base as discussed in further detail below.

External data stores 200 may also be present according to the teachings of the present invention. External data stores 200 may comprise one or more external databases, data sets, systems, applications, rules bases and/or other sources of data which is used by FSS 100 to generate fraud scores and/or to generate and/or update the rules bases used by FSS 100 as further described herein. By way of example, external data stores 200 may comprise credit reporting databases, demographic databases, reported and known fraud data, financial transaction data as well as other sources of data useful to FSS 100 in generating accurate fraud scores via rules based methodologies.

Returning now to the specific components of FSS 100, FSS 100 may include various components for generating fraud scores. In one embodiment, these components may include application interface 120 (described above), active rules base 410, pending rules base 420 and the various components of FSE 300. Each of these components and their associated functionality are more fully described below.

FSS 100 may reside on one or more physical servers. These servers may include electronic storage, one or more processors, and/or other components. The servers may also include communication lines, or ports to enable the exchange of information with a network and/or other computing platforms. The servers may include a plurality of hardware, software, and/or firmware components operating together to provide the functionality attributed herein to FSS 100.

Electronic storage associated with the servers may comprise non-transitory storage media that electronically stores information. The electronic storage media of electronic storage may include one or both of system storage that is provided integrally (i.e., substantially non-removable) with servers and/or removable storage that is removably connectable to the servers via, for example, a port or a drive.

Electronic storage may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage may include one or more virtual storage resources (e.g., cloud storage, a virtual private network, and/or other virtual storage resources). Electronic storage may store software algorithms, information determined by processors, information received from servers, information received from clients 220, and/or other information that enables the servers to function as described herein.

While an exemplary architecture is described above, it will readily be understood by one of skill in the art, that an unlimited number of architectures and computing environments are possible while still remaining within the scope and spirit of the present invention.

Returning now to the specific components of FSS 100 shown in FIG. 1, FSE 300 includes various modules which are now generally described. The operation of each of these modules will be described in further detail below. In a preferred embodiment of the present invention, cleansing module 310 cleanses feedback data received from clients 220 such that variations in data format and classification can be normalized and used by FSE 300 to update one or more pending rules bases 420 to perform more effectively. While only one pending rules base 420 is shown in FIG. 1, in practice, multiple pending rules bases may exist as feedback data is received from various clients 220 and prior to the time that these pending rules bases are invoked as an active rules base 410.

Rules bases may be used generally or, in some cases, they may be broken down by customer by some other classification. For example, FSS 100 may function such that for customer 1 (e.g. BANK A), a specific active rules base 410 (Base #1) may be used for that customer to generate fraud scores in connection with new credit card request decisioning to be made by BANK A. Further, another active rules base 410 (Base #2) may be used for initial mortgage lending qualification decisioning to be made by BANK A. In connection with this, there may be one or more pending rules bases 420 associated with each of Base #1 and Base #2 which are continually being updated according to the teachings of the present invention based on feedback data and in accordance with the teachings of the present invention. At some point, and as more fully described herein, pending rules base 420 may be substituted for active rules base 410 to make pending rules base 420 the new active rules base 410.

This can occur with respect to each active rules base 410 in use by FSS 100 for the benefit of multiple different customers requesting fraud scores from FSS 100. Similarly, various other active rules base 410/pending rules base 420 pairs may exist for other customers (customers 2, 3 . . . n) and for each of their specific decisioning requirements.

Along these lines, it will be understood by one of skill in the art that feedback data received may come from a source which is different than the component or application which requests fraud scores. In other words, and for example, Bank A may request fraud scores via client 220a while feedback data coming from Bank A may be provided to FSS 100 by Bank A via client 22a or, alternatively via another client or another methodology such as a direct FTP transfer or some other known methodology for providing the relevant electronic data to FSS 100. Similarly, it will be understood by one of skill in the art that while feedback data from one customer (e.g. Bank A) may be used for the limited purpose of updating pending rules bases 420 used by that same customer (Bank A), it is also possible to employ feedback data from one customer (e.g. Bank A) to update pending rules bases 420 to be used by one or more other customers (e.g. Bank B, Lender C, etc.).

Returning now to the discussion of the other components of FSE 300, rules base merge 320 functions to merge new training sets developed in connection with feedback data with the existing rules already present in pending rules base 420. Model update module 330 then updates pending rules base 420 to create a new model reflecting the update rules base. This updated model may contain new rules as well as rules which have been newly optimized based on the recently received training sets derived from the feedback data received from clients 220.

Model assessment module 340 then assesses the newly developed model resulting from model update 330. In a preferred embodiment this assessment comprises comparing the newly developed pending rules base 420 as against the currently in use active rules base 410 to determine whether the pending rules base 420 is statistically significantly improved over the current active rules base 410, Once this occurs, then, in some embodiments, bias testing module 350 is engaged to perform automated protected-class bias tests on the pending rules base 420 which may include tests against both the distribution and individual utilized predictors.

Assuming that the pending rules base 420 passes this bias testing, then model management module 360 operates to substitute the pending rules base 420 for the current active rules base 410 after which model management module will initiate one or more new pending rules bases 420 associated with the new active rules base 420 so that additional feedback data can be employed to continually update and optimize the relevant model as feedback data is received over time. Model management module 360 may also function to alert the relevant client(s) 220 concerning a newly rolled out active rules base 410 as well as provide any information and/or documentation which is required or useful in connection with client's use of the model as it has been updated. In some embodiments, this information may also include new or different information regarding the type and/or format of feedback data which is required/desired in connection with client's use of the new model.

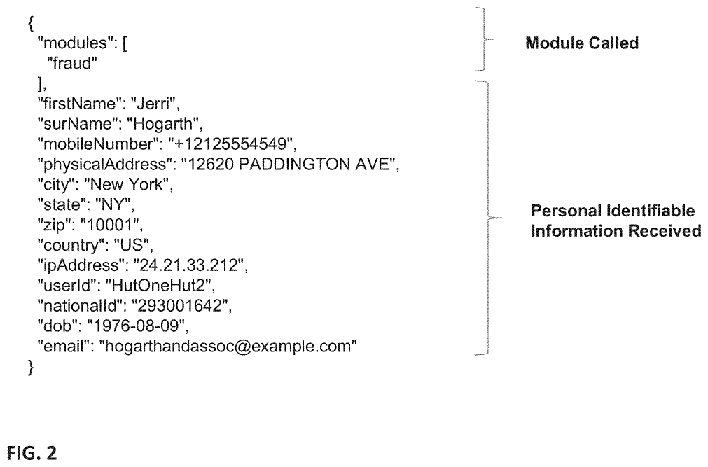

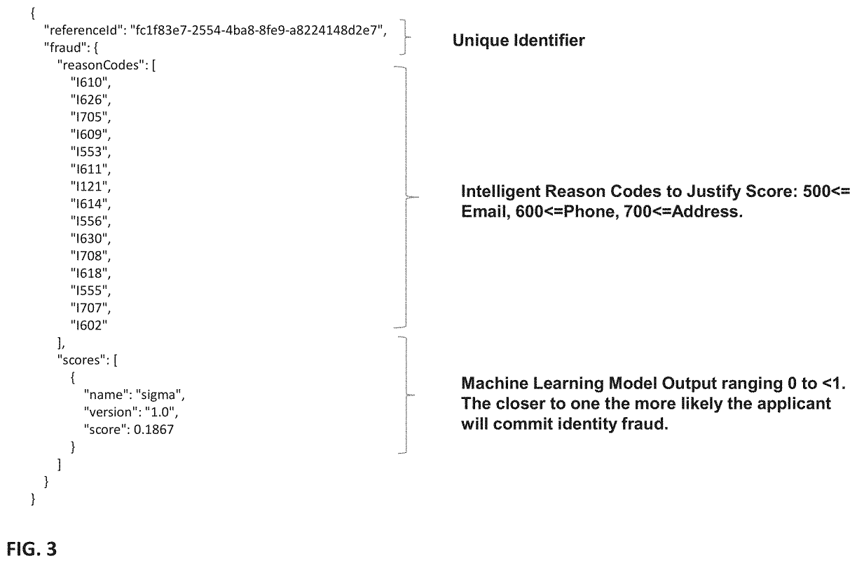

With reference now to FIGS. 2 and 3, exemplary call data and returned fraud score data, respectively, in one embodiment of the present invention, is provided. FIG. 2 shows exemplary data that may be provided by client 220 to FSS 100 in connection with a request for a fraud score. In preferred embodiments, the format of these calls is specified via application interface 120 and client 220 is configured to provide data in this required format. In this example, the name, mobile phone number, physical address, IP address (of the computing device used by the customer in attempting the transaction), userid, national id, date of birth and email address are all passed to FSS 100 by client 220 in connection with the fraud score request. This personally identifiable information is used by FSS 100 to generate a fraud score using the rule based models available to it and as further discussed below.

FIG. 3 is an exemplary set of data returned to client 220 by FSS 100 following the completion of the fraud scoring process which is invoked by the client request. In this case, a referenceid is assigned to the request response. This referenceid is also used in connection with the novel feedback reporting and model updating process of the present invention. When feedback data is later reported to include those transactions which were ultimately fraudulent, this referenceid value is used to match the reported feedback data with the data generated and used by FSS 100 in originally conducting the fraud score analysis such that the rules in the model can be optimized as discussed in further detail below.

In preferred embodiments, the data returned by FSS 100 to client 220 also include a fraud score indicative of the likelihood that the transaction will be fraudulent. In some embodiments, the score ranges from 0 to 1 and the higher the value, the more likely that the transaction is expected to be fraudulent. In some embodiments, the returned data may also include one or more reason codes (such as matching of email address, phone number and/or physical address and the like) which reflect the justification for the fraud score. These reason codes may tie to specific rules used in the model to arrive at the final reported fraud score.

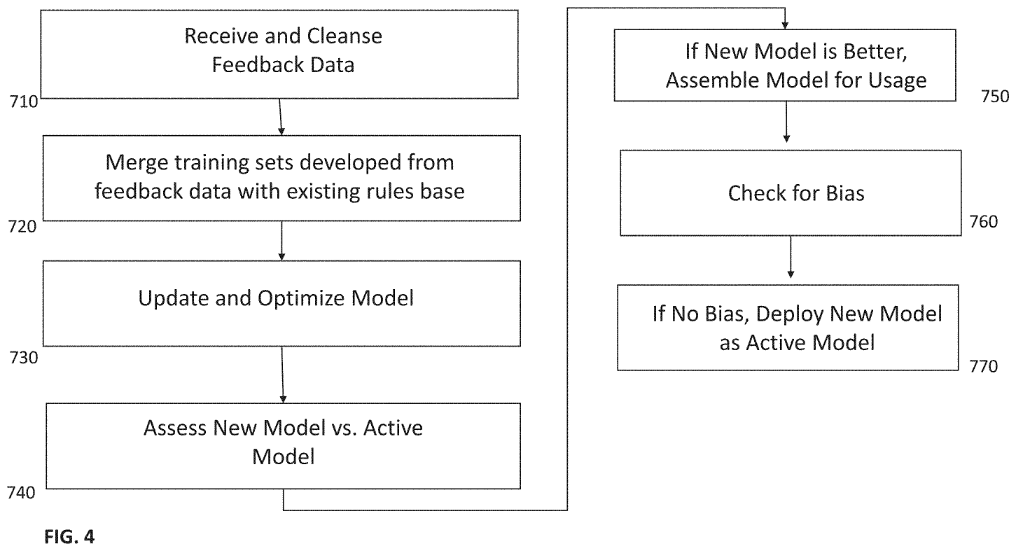

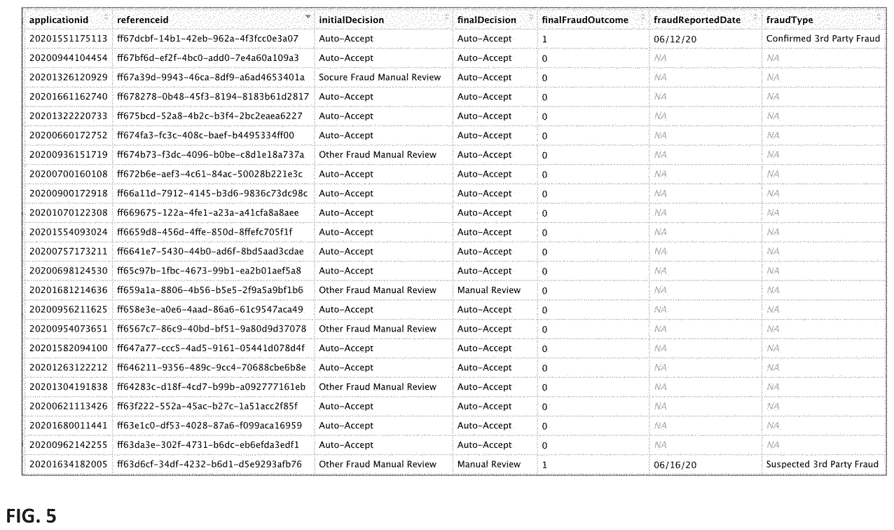

Turning now to FIGS. 4 and 5, a flowchart describing the steps in the process of optimizing rules based models using feedback data as well as an exemplary set of feedback data, respectively, according to the teachings of the present invention, are provided. The discussion that follows is an exemplary process for using feedback data to optimize a model. In this discussion it is assumed that a single feedback data set is received from a single client 220 and further that the feedback data set is used to update a single model used on behalf of that client. As will be understood by one of skill in the art, the scope and spirit of the present invention is not necessarily limited thereto. For example, and as referenced above, more than one data set may be received at one time and may be applied to optimize one or more models.

As noted, it is also possible for feedback data sets received from one client 220 (representing use by Customer A) to be employed to optimize models used on behalf of other customers (e.g. Customer B) and/or for received feedback data sets to be used to optimize “universal” models which are employed on behalf of multiple customers which receive fraud scores and make binary decisions based thereupon. Similarly, while the discussion references receipt of feedback data from clients 220, the invention is not necessarily limited thereto in that feedback data can be provided to FSS 100 via any other means whereby an electronic data file is made available to FSS 100.

Beginning at step 710, FSS 100 receives feedback data from client 220. This feedback data is provided, in some embodiments, through application interface 120 which allows data to be formatted and shared with FSS 100 in a manner which is anticipated by FSS 100. In any event, although feedback data formatting requirements may be specified, often, the data may not be provided in exactly the format expected so at step 710, cleansing module 310 operates to clean and standardize the received feedback data. This may include, for example, renaming labels associated with data, standardizing data formatting and ensuring that the specific data received is matched with the specific class of data to which it is intended to apply.

During this step 710, cleansing module 310 may also operate to discard some or all of the feedback data received if it determines that there are material errors in the data and/or if data can not be matched with expected data classifications. For example, if a series of transaction identity values are in a completely incorrect format, FSE 300, and in particular, cleansing module 310, may discard some or all of the data associated with those transactions or, alternatively, it may lessen the weight placed upon those transactions when those transactions are used in optimization as discussed below. The system of the present invention may also operate, in some embodiments, to discard some or all of the transactions reported as fraudulent if it is determined that the basis for fraud is likely to be something other than identity theft.

With reference now to FIG. 5, and to aid in the discussion, an exemplary feedback data set is provided. In one embodiment, cleansing module 310 will operate to ensure that feedback data is formatted such that the received data is matched with one of the columns of FIG. 5 and associated therewith. So, for example, cleansing module 310 will attempt to match some of the received data with the referenceid column. Preferably, when received from client 220, the correct data will be assigned to that label but even if there is a mislabeling in the data received from client 220, cleansing module 310 will operate to attempt to identify all data which should be associated with that column and associate it therewith.

At step 720, the newly received and cleansed feedback data is adapted to reflect training sets which can be used in later steps to update rules based on known outcomes, So, for example and with reference to the data set in FIG. 5, and in particular the first data row thereof (row with applicationid 20201551175113) it is now known that this transaction turned out to be fraudulent (based on the “1” value in the finalfraudoutcome column). Because this transaction was allowed to proceed based upon a generated fraud score in the past as well as a binary decision made based on that fraud score value, it is valuable to address the basis for the undesirable outcome—namely the generation of a fraud score that was determined to meet a threshold to allow the transaction to proceed, when, in fact, it shouldn't have been permitted to proceed. At this step, transactions such as these, including the reported feedback data associated with these transactions (e.g. the data in the fraudreporteddate and fraudtype columns) are used to generate training sets which are, in turn, used to optimize the models as discussed below.

Next, at step 730, the received feedback data is used by rules base merge module 320 to supplement and optimize the current rules base associated with the model, A model may have, for example, on the order of 5000 rules from which fraud scoring can be accomplished. From time to time, new rules may be added to the model and the feedback data can be used to “seed” outcomes for these new rules. In addition, the feedback data is also used with existing rules to optimize their performance outcomes. In other words, with the dependent variable being either an expected fraudulent transaction or an expectation that a transaction will NOT be fraudulent, and the independent variables being external data used to drive the value of the dependent variable (each a rule), the mapping relationship between each independent variable and the dependent variable is adjusted based on feedback received.

By way of example, assume that one rule in a model is “Requesting IP Address Location Distance from Home IP Address”. This rule may be employed as one factor in generating a fraud score and may take into account how far the user is from their known home IP address when they attempt the transaction based on location of their computing device as reflected by their IP address. According to the teachings of the present invention, the mapping of this distance value to a component value of a fraud score may be updated through the use of the feedback data. In this case, and by way of example, the transaction in the first row of FIG. 5 could be used to “re-train” this rule. Thus, FSE 300 maps the referenceid to recall all of the known independent variables at the time the original fraud score was generated. In this example, if the IP location distance mapping to the fraud score component generated a fraud score component that leans toward permitting the transaction to occur, this rule may now be adjusted in hindsight since it is now known that this transaction turned out to be fraudulent. This would occur if FSE 300, and in particular model update module 330, determines that this independent variable impacts the model outcome in a way that the mapping should be adjusted for this rule.

As the process continues, and during step 730, each rule in the model is considered for updating and is updated as required based upon the available feedback data. In some cases, existing rules are updated based upon the new known outcomes and a re-run of the model to assess the validity of the rule mapping for that existing rule. In other cases, new rules (e.g. new independent variables) have been selected for possible inclusion in the model and these new rules are backtested against previous transactions to develop an initial mapping.

As more and more feedback data is received, these new rules continue to be updated and optimized such that the mapping from independent variable to dependent variable outcome reflects a more accurate assessment based upon known data. In preferred embodiments of the present invention, fraudreporteddate data is used in this analysis such that more recently reported fraudulent transactions are given more weight in optimizing the applicable rules. Similarly, fraudtype data may also be used in determining the weight and applicability for each of the fraudulent transactions and how they should be used to adjust the mapping for one or more rules in the model.

Next, at step 740, and now that a new development version of a model 420 has been created, the expected performance of this development model is measured against the known and expected performance of the active model 410. This function is performed by model assessment module 340 by re-running the fraud score analysis using both models and checking outcomes against reported fraud data received in connection with the feedback data. If it is determined that performance of the development version 420 is not statistically significantly better than the performance of the active model 410, then no change in active model is made. Rather, FSS 100 continues to receive more feedback data and the model is continually updated over time until such time as the performance of the development version 420 IS statistically significantly better than the performance of the active model 410.

Once this happens, the process continues to step 750 at which time the new model is assembled for usage in connection with one or more customers. Optionally, the process, at step 760, may then assess the newly developed model for inherent bias against one or more protected classes as may be required by law, regulation and/or policy. If bias is found at step 760 then the new model may be rejected as a potential active model and updating of the model may continue using feedback data until such time as bias testing is passed. In addition or alternatively, human intervention may be manually imposed to adjust the model to remove or reduce bias such that the model can be adapted as a new active model.

Finally, at step 770, FSE 330, under the control of model management module 360, will substitute the new pending model as the new active model if performance testing and bias testing allow. This step may also include automatically notifying one or more customers via clients 220 of the update to the model as well as providing any information that customers should know about the new model and/or updates to the required format for providing feedback data.

In some further embodiments of the present invention, other processing steps may also be implemented to optimize the accuracy of machine learning model score distributions. These distributions are highly dependent on the training data dependent variable distribution, selected independent variables and the final chosen machine learning algorithm. When updating models in real-time, dependent variable distributions, independent variables and final machine learning algorithms will vary. This creates a challenge for those using the scores. For example, because of this variability, it may be difficult for a financial institution to make an educated binary decision whether to accept/decline financial applications.

One solution to this is for the system of the present invention to include a model scores normalization capability which assess previous production distributions on a per client basis based on different timeframes/volume. The scores are then normalized based on mimicking previous models thus allowing clients to keep the very same established decisioning thresholds while using a new model which shows improved performance as a result of latest feedback and inclusion of new independent variables as is discussed above.

In other further embodiments of the present invention, a real time model recommender capability may be included. B2B businesses spend a significant amount of time to properly setup client's API accounts enabling the correct product and services needed to best serve clients. Furthermore, companies that providing the related scores do not necessarily know they are serving the best scores in real-time. For example, assume ModelX was built and optimized to receive the following identity inputs—(Name, SSN, DOB, Phone, Email and IP Address) and further CreditCardBank-A is passing all of the inputs used to optimize ModelX. Further assume that CreditCardBank-B is not passing the email address during real-time calls. As a result, we know that ModelX will not perform as expected so the best model to serve back in real-time is a model that is optimized on NOT using email address as an input. This problem thus results because the scoring systems are not serving the best possible score taking into consideration the real-time inputs.

In addressing this problem, the system of the present invention may include a real time model recommender functionality that takes into consideration real-time identity PII inputs, client metadata (Industry, fraud rates, others) to recommend the best possible model (from a list of production models) to serve back to the client to enable the client's automated binary decision. According to preferred embodiments, the system of the present invention is able to intelligently and in real time, assess models and clients inputs and find the best model matches optimized on optimum fraud capture.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims.

1. A system configured to generate scores, the system comprising:
a computer comprising a physical storage capability, and one or more processors configured to solely execute each of
an active rules base contained within said physical storage capability, said active rules base defining at least a first model comprising a plurality of rules, and said model being operative to apply said plurality of rules to transaction data corresponding to a first, potential transaction and to generate at least a first score for said first, potential transaction based on the application of said plurality of rules of said at least a first model;
a pending rules base contained within said physical storage capability;
a rules base merger operative to receive and process feedback data subsequent to said scoring comprising said at least a first score and execution of said first, potential transaction, said processing comprising generation of training based on said processed feedback data;
a model updater operative to (a) receive said processed feedback data from said rules base merger, (b) optimize at least one rule of said pending rules base according to said training, and in response to said processed feedback data matching one or more variables of said transaction data, and (c) create at least a second model comprising said optimized pending rules base, and which is operative to apply said at least one rule of said optimized pending rules base to said transaction data to generate a score therefor based on the application of said at least one rule of said optimized pending rules base of said at least a second model;
a model assessor operative to solely feed said transaction data to each of said at least a first model and said at least a second model at a same time for scoring said first, potential transaction, and to directly determine whether said scoring of said first, potential transaction as generated by said at least a first model at said same time or said scoring of said first, potential transaction as generated by said at least a second model at said same time more accurately reflects said processed feedback data; and
a model manager operative to substitute said at least a second model for said at least a first model in response to said scoring of said first, potential transaction as generated by said at least a second model at said same time more accurately reflecting said processed feedback data, wherein said at least a second model is then operative, upon being substituted, to generate a second score for a second, potential transaction.

2. The system of claim 1 wherein said scores are fraud scores and said fraud scores are employed to make a binary decision regarding each of said first and second potential transactions.

3. (canceled)

4. The system of claim 1 further comprising a bias tester operative to determine whether said at least a second model meets predetermined bias testing criteria prior to substitution of said at least a second model for said at least a first model.

5. The system of claim 1 wherein said scores are provided to an external transaction system, said external transaction system employing said scores to make binary transaction determinations.

6. The system of claim 1 wherein said processed feedback data comprises information indicative of whether a transaction, resulting from said execution of said first, potential transaction, was identified as being fraudulent.

7. The system of claim 6 wherein data associated with said transaction identified as being fraudulent is employed to update one or more rules contained in said pending rules base.

8. The system of claim 1 wherein said system is resident on a computer server and wherein said system communicates with one or more clients via an application interface.

9. The system of claim 8 wherein said clients generate score requests and wherein said system communicates scores to said clients.

10. The system of claim 1 wherein said transaction data comprises information associated with an individual seeking to effect a transaction.

11. The system of claim 6 wherein said processed feedback data further comprises a fraud reported date and wherein data associated with said transaction and comprising a recent fraud reported date is given more weight than data of another transaction comprising an older fraud reported date in connection with the optimization of rules contained in said pending rules base.

12. A computer-implemented method of optimizing a model used in generating scores, the method being implemented in a computer system comprising one or more processors configured to execute computer program modules solely implementing steps comprising:
receiving feedback data in response to a current active model being fed a first transaction request which had been scored, said feedback data comprising an indicator as to whether a transaction associated with said first, scored transaction request was actually fraudulent;
generating training based upon the feedback data;
updating at least one rule within a pending model (a) based upon said training, for said at least one rule, and (b) in response to said feedback data matching one or more variables of said first, scored transaction request;
feeding said first, scored transaction request to said updated pending model and said current active model, at a same time, for scoring of said first, scored transaction request by each of said updated pending model and said current active model;
assessing whether said scoring by said updated pending model at said same time or said scoring by said current active model at said same time more accurately reflects said indicator; and
if said scoring by said updated pending model at said same time more accurately reflects said indicator, then substituting said updated pending model as a new current active model for scoring a second transaction request.

13. The method of claim 12 wherein said scores are fraud scores and said fraud scores are employed to make a binary decision regarding said transaction.

14. The method of claim 13 wherein said current active model and said updated pending model each comprise at least one rule, each said at least one rule mapping an independent variable, of said one or more variables of said first, scored transaction request, to a fraud score value.

15. The method of claim 12 further comprising the step of assessing whether bias exists in said updated pending model prior to said step of substituting said updated pending model as a new current active model.

16. The method of claim 12 further comprising the step of cleansing said feedback data prior to said step of updating at least one rule within said pending model based upon said feedback data.

17. The method of claim 12 wherein said feedback data comprises data indicative of a fraud reporting date.

18. The method of claim 17 wherein, if said transaction comprises a more recent fraud reporting date than does another transaction comprising a comparatively older fraud reporting date, said transaction is weighted more heavily than said another transaction in connection with said step of updating said at least one rule within said pending model.

19. The method of claim 12 further comprising the step of reporting the adaptation of said new current active model, based on the substitution of said updated pending model, to one or more users.

20. The system of claim 1, wherein said feedback data is defined by one or more entities for which said at least a first score was generated and said first, potential transaction was executed by each of said one or more entities.

21. The method of claim 12, wherein said feedback data is defined by one or more entities for which said first transaction had been scored for said one or more entities.
